(19) United States
(12) Patent Application Publication
(10) Pub. No.: US 2006/0292522 A1
(43) Pub. Date: Dec. 28, 2006

(54) Splatter shield for dental cleaning instrument

(76) Inventors: Shon T. Lees, Parkland, FL (US); Lisa Pompile, Parkland, FL (US)

Correspondence Address: ROBERT M. DOWNEY, P.A., 6751 N. FEDERAL HWY., SUITE 300, BOCA RATON, FL, 33487, US

(21) Appl. No.: 11/434,443

(22) Filed: May 15, 2006

Related U.S. Application Data
(60) Provisional application No. 60/692,895, filed on Jun. 22, 2005.

(51) Int. Cl. A61C 1/16; A61C 3/06

(52) U.S. Cl. 433/116; 433/125

(57) ABSTRACT

A disposable guard device for removable attachment to a dental cleaning instrument which uses a prophy angle with a spinning prophy cup to polish tooth surfaces. The device is formed of a flexible, resilient material and includes an attachment portion and an integral dome portion. The attachment portion is structured and disposed for removable, snug fitted receipt over the head and neck of the prophy angle to securely hold the dome portion in surrounding relation to the prophy cup, thereby providing a shield that prevents splatter of cleaning paste and bodily fluids when cleaning the teeth of a patient. The wall forming the dome portion is transparent to allow visibility of the prophy cup against the tooth surfaces during cleaning.

### BACKGROUND OF THE INVENTION

This application is based on provisional patent application Ser. No. 60/692,895 filed on Jun. 22, 2005.

### FIELD OF THE INVENTION

This invention relates to an accessory for a dental tool and, more particularly, to a disposable splatter shield for removable attachment to a prophy angle in order to prevent splatter of water, cleaning paste and bodily fluids when cleaning a patient's teeth.

### DISCUSSION OF THE RELATED ART

In the dental profession, tooth cleaning is a very common procedure which is performed with use of a prophylactic device most commonly known as a prophy angle. The teeth are cleaned by the dental practitioner using the prophy angle. The prophy angle drives a small, rotary, elastomeric cup at an angle to the hand piece of the device. The rubber cup, referred to as a prophy cup, contains a mild abrasive tooth cleaning paste. In use, the power driven rotary cup is pressed against the tooth surfaces as it spins, and the abrasive tooth cleaning paste forms an abrasive slurry. The rotating action of the prophy cup combined with the abrasive slurry serve to clean the tooth surfaces.

Splatter is a long standing problem that occurs during the tooth cleaning procedure. This happens when the cleaning paste and saliva are thrown from the edges of the prophy cup due to the centrifugal force generated by the spinning action of the cup. Specifically, the abrasive slurry between the cup and tooth surfaces attaches with the patient's saliva and migrates to the outer's edges of the cup. As the cup spins, this mixture of abrasive slurry and saliva is thrown from the cup as a contaminated splatter. Operating the prophy cup into the spaces under the gums adds blood pathogens to the slurry, raising the level of contamination in the splatter. As a result, there is a danger of the attending practitioner being infected from the contaminated splatter during the tooth cleaning procedure. Accordingly, there remains a definite need for protection from bodily fluids in dentistry and, more particularly, an effective device to contain splatter of cleaning paste and patient bodily fluids during the tooth cleaning procedure so that the attending practitioner is protected from contamination.

In the past, others have proposed various devices for use in conjunction with a prophy angle to assist with reduction of splatter released from the prophy cup during the tooth cleaning procedure.

For instance, the Hall U.S. Pat. No. 5,131,846, discloses a prophy cup shield that attaches to the nose of the prophy angle by way of an elastic fit. The inside surface of the shield engages the bottom outer edge of the prophy cup. The shield device in Hall does not securely fit over the head and neck of the prophy angle and, therefore, can be dislodged during the teeth cleaning procedure. Moreover, engagement of the shield with the rotating cup may interfere with the spinning operation of the prophy cup. Additionally, the shield device in Hall is not transparent. Thus, it is difficult to view engagement of the prophy cup with the teeth during the cleaning procedure.

The Maassarani U.S. Pat. No. 5,584,690, discloses a series of flexible bristles secured to the head of a dental cleaning instrument, in close, surrounding relation to the prophy cup to provide an anti-splatter shield. The flexible bristles on the Maassarani dental cleaning assembly are separable from one another and do not provide a completely enclosed shield around the prophy cup. Moreover, because the bristles are not transparent, it may be difficult to view the prophy cup against the tooth surfaces during the cleaning procedure.

The Spinello U.S. Pat. No. 5,690,488, discloses a uniquely shaped prophy cup which is designed to minimize splatter during teeth cleaning. While the Spinello prophy cup does afford full visibility to the operator of the cleaning instrument, there is no shield to block splatter. The Spinello prophy cup minimizes splatter but does not provide for a shield to completely block and contain splatter of cleaning paste and bodily fluids during the teeth cleaning procedure.

### OBJECTS AND ADVANTAGES OF THE INVENTION

Considering the above, it is a primary object of the present invention to provide a shield device for attachment to a prophy angle to protect against splatter of water, cleaning paste, saliva, blood and bacteria during the tooth cleaning process.

It is a further object of the present invention to provide a splatter shield for a prophy angle which is disposable, easily attached and removed from the prophy angle and yet securely held in place during the cleaning process.

It is still a further object of the present invention to provide a disposable splatter shield which removably attaches to the head and neck of the prophy angle to securely hold a dome portion of the shield in surrounding relation to the prophy cup.

It is still further object of the present invention to provide a splatter shield which is formed of a flexible, resilient material to allow a dome portion of the device to partially deform or collapse when pressed against tooth and gum surfaces during the cleaning process, so as to avoid discomfort and injury to the patient.

It is still a further object of the present invention to provide a disposable splatter shield for removable attachment to a prophy angle, wherein the splatter shield includes a dome portion having a wall structure which tapers in thickness towards a bottom edge to promote flexibility.

It is still a further object of the present invention to provide a disposable splatter shield for removable attachment to a prophy angle of a dental cleaning instrument, and wherein the shield device includes a transparent dome portion which surrounds the prophy cup and allows visibility of the prophy cup against the tooth surfaces during cleaning.

These and other objects and advantages of the present invention are more readily apparent with reference to the following detailed description and accompanying drawings.

### SUMMARY OF THE INVENTION

The present invention is directed to a disposable guard device for removable attachment to a dental tool. In particular, the guard device attaches to a prophylaxis having a prophy angle with a neck and a head, and a prophy cup that holds a charge of cleaning paste. In operation, the cup spins and is moved in contact with a patient's teeth for polishing tooth surfaces. The guard device of the present invention is formed of a flexible, resilient transparent material and includes an attachment portion and an integral dome portion. The attachment portion is structured and disposed for removable, snug fitted receipt over the head and about the neck of the prophy angle to securely hold the dome portion in surrounding relation to the prophy cup, thereby providing a shield that prevents splatter of water, cleaning paste and bodily fluids when cleaning a patient's teeth. The dome wall is transparent to allow visibility of the prophy cup through the dome, so that the operator of the device can view the position of the prophy cup against the tooth surfaces during cleaning. The dome wall may be made to taper in thickness towards the bottom free edge to promote flexibility when pressed against tooth surfaces and surrounding gum tissue.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view, in partial cross-section, showing the shield device of the present invention fitted to the prophy angle head and neck with the dome portion of the shield surrounding the prophy cup;

FIG. 2 is a top plan view of the shield device;

FIG. 3 is an end elevational view of the shield device in partial cross-section;

FIG. 4 is a top perspective view of the shield device; and

FIG. 5 is a perspective view showing the shield device in use on the prophy angle with the prophy cup pressed against a tooth surface and the shield device surrounding the prophy cup during a teeth cleaning procedure.

Like reference numerals refer to like parts throughout the several views of the drawings.

### DETAILED DESCRIPTION OF THE PREFERRED EMBODIMENTS

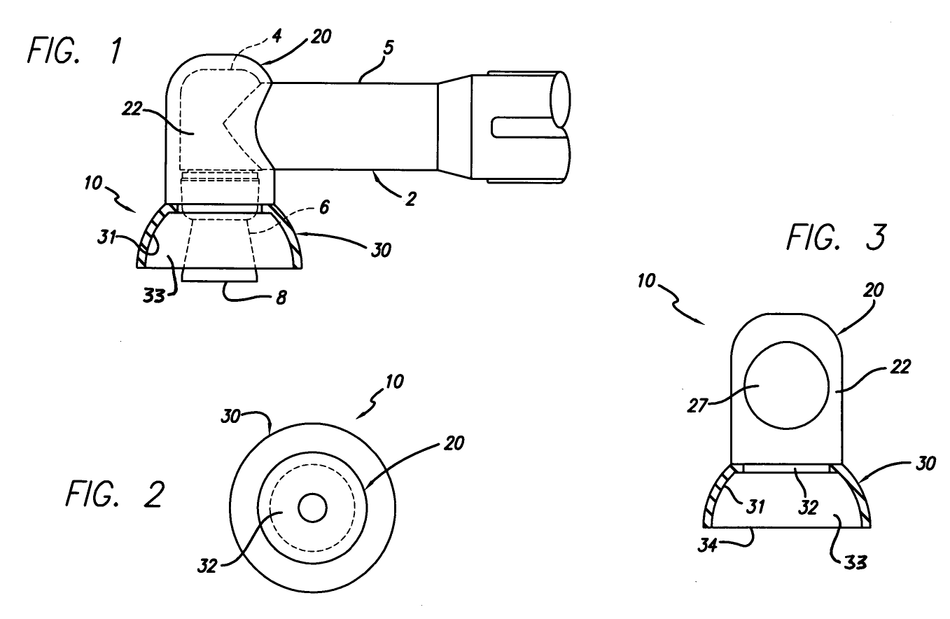

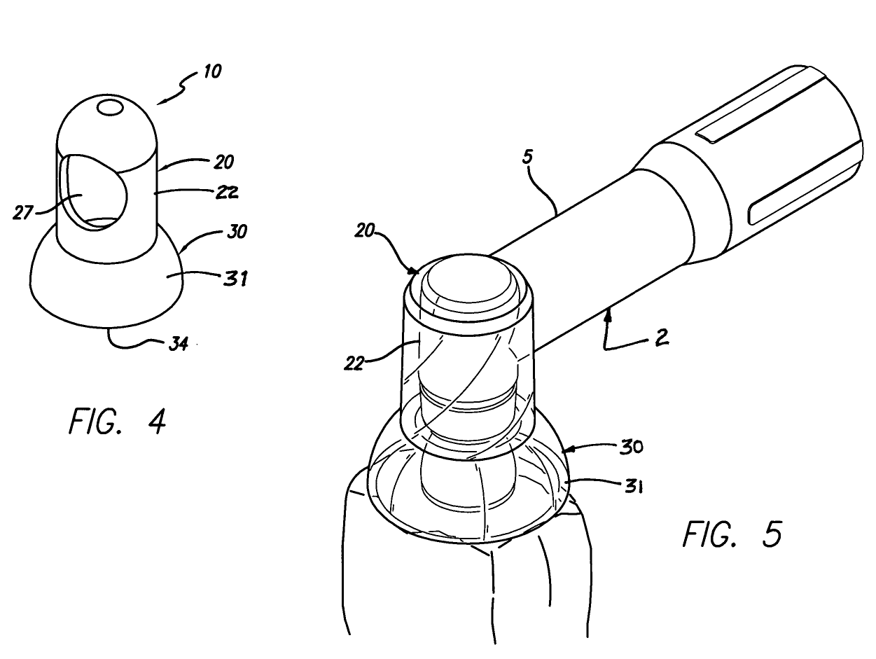

Referring to FIGS. 1-5, the disposable shield device of the present invention and is shown and is generally indicated as 10. More specifically, the shield device 10 provides a splatter shield on a dental cleaning instrument which uses a prophy angle 2 having a head 4 and a spinning prophy cup 6 fitted to a spindle or stem extending from the head 4. The prophy cup 6 is formed of a flexible, relatively soft material and is provided with a hollow bottom end 8 for holding a charge of cleaning paste.

The shield device 10 includes an attachment portion 20 and a dome portion 30. In a preferred embodiment, the entire device 10, including the attachment portion 20 and dome portion 30, is formed of the same flexible, resilient material. The material may be a dental grade latex or other suitable elastomeric material which holds it's shape and yet is relatively soft and flexible to avoid discomfort and injury when contacting the gum tissue of the patient during the teeth cleaning procedure.

The attachment portion is specifically sized and configured for removable, snug fitted receipt over the head 4 and neck 5 of the prophy angle 2, as shown in FIG. 1. Specifically, the attachment portion 20 is formed with a main body 22 that extends upwardly from a top of the dome portion 30. The main body 22 is formed to have a side opening 27. The attachment portion 20 surrounds an opening 32 formed in the top of the wall structure of the dome portion 30. The opening 32 is sized to permit passage of the prophy cup 6 therethrough. The side opening 27 in the main body 22 surrounds and snugly engages the neck 5 of the prophy angle. As seen in FIGS. 1 and 5, the main body 22, and side opening 27 are formed and configured to wrap around the neck 5 and head 4 of the prophy angle 2 in order to securely hold the shield device 10 in fixed, attached position on the prophy angle.

The dome portion 30 extends downwardly from the attachment portion 20 and terminates at a bottom edge 34. The wall structure 31 of the dome portion 30 may be made to taper in thickness so that the thinnest section of the wall structure is near the bottom edge 34. This allows for greater flexibility of the lower half of the dome portion 30. As seen in FIG. 1, the bottom edge 34 of the dome portion is positioned above the lower end 8 of the prophy cup 6, thereby allowing the end 8 of the prophy cup to engage the tooth surfaces and partially collapse without interference of the dome portion 30, as seen in FIG. 5. At times, a section of the bottom edge 34 of the dome portion 30 may come into contact with tooth surfaces or gum tissue without interfering with the spinning operation of the prophy cup 6. The wall structure 31 surrounds an interior area 33 defining a splatter containment chamber. In the preferred embodiment, the dome portion 30 is transparent to permit visibility of the prophy cup 6 against the tooth surfaces during the teeth cleaning procedure. Because the entire shield device 10 is formed as an integral, one piece unit, the attachment portion 20 may also be transparent.

The shield device 10 is structured for ease of attachment and removal from the prophy angle 2 and is intended for a single use. When fitted to the prophy angle 2, as shown in FIG. 1, the dome portion 30 of the shield device 10 substantially surrounds the prophy cup 6, with the prophy cup protecting concealed within the splatter containment chamber 33, thereby providing a shield that blocks cleaning paste, saliva and bodily fluids being thrown from the rotating prophy cup. Thus, the shielding action of the dome portion 30 serves to prevent splatter while containing cleaning paste, saliva, and bodily fluids within the patient's mouth and primarily within the confines of the dome portion 30.

While the instant invention has been shown and described in accordance with a preferred and practical embodiment thereof, it is recognized that departures from the instant disclosure are contemplated within the spirit and scope of the present invention.

What is claim is:

1. A device for removable attachment to a dental cleaning instrument that has a neck, a head and a cup that spins and holds a cleaning material for polishing tooth surfaces, said device comprising:
an attachment portion structured and disposed for removable, snug fitted receipt over the head and about the neck of the dental cleaning instrument; and
a dome portion integrally formed with said attachment portion and said dome portion including a wall that surrounds the cup when said attachment portion is fitted over said head, said wall extending downwardly and outwardly from said attachment portion and terminating at a bottom edge, and said dome portion being structured and disposed to block and contain splatter of cleaning paste and bodily fluids as the cup spins during use of the dental cleaning instrument to clean teeth.

2. The device as recited in claim 1 wherein said attachment portion and said dome portion are integrally formed as one piece.

3. The device as recited in claim 2 wherein the device, including said attachment portion and said dome portion, is formed of a flexible, resilient material.

4. The device as recited in claim 3 wherein said flexible, resilient material is transparent.

5. The device as recited in claim 1 wherein said attachment portion is defined by a main body extending upwardly from said dome portion and including an interior space communicating with an area surrounded by said dome portion, and said main body being congruently formed and configured for snug fitted receipt of the head of the dental cleaning instrument within the interior space, and said main body further including an opening that is sized and configured for passage of the neck of the dental instrument therethrough.

6. A device for removable attachment to a dental cleaning instrument that has a neck, a head and a cup that spins and holds a cleaning material for polishing tooth surfaces, said device comprising:
an attachment portion structured and disposed for removable, snug fitted receipt over the head and about the neck of the dental cleaning instrument; and
a dome portion integrally formed with said attachment portion and said dome portion including a wall extending downwardly and outwardly from said attachment portion and terminating at a bottom edge, and said wall surrounding an interior area defining a splatter containment chamber for receiving the cup of the dental cleaning instrument, and said dome portion being structured and disposed to block and contain splatter of cleaning paste and bodily fluids as the cup spins during use of the dental cleaning instrument to clean teeth.

7. The device as recited in claim 6 wherein said dome portion is formed of a flexible, resilient material.

8. The device as recited in claim 7 wherein said attachment portion is formed of a flexible, resilient material.

9. The device as recited in claim 7 wherein said flexible, resilient material of said dome portion is transparent.

10. A device for removable attachment to a dental cleaning instrument that has a neck, a head and a cup that spins and holds a cleaning material for polishing tooth surfaces, said device comprising:
an attachment portion structured and disposed for removable, snug fitted receipt over the head and about the neck of the dental cleaning instrument;
a dome portion integrally formed with said attachment portion and said dome portion including a wall that surrounds the cup when said attachment portion is fitted over said head, said wall extending downwardly and outwardly from said attachment portion and terminating at a bottom edge, and said dome portion being structured and disposed to block and contain splatter of cleaning paste and bodily fluids as the cup spins during use of the dental cleaning instrument to clean teeth; and
said attachment portion and said dome portion being formed of a flexible, resilient material.

11. The device as recited in claim 10 wherein said flexible, resilient material is transparent.

12. The device as recited in claim 10 wherein said attachment portion is defined by a main body extending upwardly from said dome portion and including an interior space communicating with an area surrounded by said dome portion, and said main body being congruently formed and configured for snug fitted receipt of the head of the dental cleaning instrument within the interior space, and said main body further including an opening that is sized and configured for passage of the neck of the dental instrument therethrough.
